(19) United States
(12) Patent Application Publication
(10) Pub. No.: US 2026/0284519 A1
(43) Pub. Date: Sep. 24, 2026

(54) Systems and Methods for Adaptive Avatar Dialog Generation and Behavioral Modeling

(71) Applicant: Board of Regents, The University of Texas System, Austin, TX (US)

(72) Inventors: Aaron M. Tate, Dallas, TX (US); Maria T. Johnson, Frisco, TX (US); Kamin L. Bouguyon, Rowlett, TX (US)

(21) Appl. No.: 19/688,234

(22) Filed: May 26, 2026

Related U.S. Application Data
(63) Continuation of application No. 17/548,887, filed on Dec. 13, 2021.

(51) Int. Cl. A63F 13/23; A63F 13/825; G06N 3/02

(52) U.S. Cl. CPC A63F 13/23; A63F 13/825; G06N 3/02

(57) ABSTRACT

A deep-learning system enables a coach to guide interactions between a user and an avatar while adaptively refining behavioral characteristics associated with the avatar. During a session, a coach provides prompts, feedback, and scoring through a dedicated interface, and the system generates avatar-matched dialog based on predefined behavioral traits, objectives, and personality attributes. The system compares automated scoring with coach-provided evaluations to identify substantive differences and dynamically update adaptive model parameters used in future dialog generation. The invention further supports real-time response suggestions, behavioral reinforcement, avatar movement controls, voice transformation, and personality-based language modification. Training data generated during sessions may be reviewed and incorporated into ongoing deep-learning processes, enabling continuous improvement of avatar behavior modeling for coaching, simulation, education, therapeutic, or interactive communication environments.

### CROSS REFERENCE TO RELATED APPLICATIONS

This application is a continuation of U.S. application Ser. No. 17/548,887, filed Dec. 13, 2021, which is incorporated herein by reference in its entirety.

### BACKGROUND

Systems, such as gaming systems, allow users to interact with each other using avatars, but such interactions are generally incidental to game objectives.

### BRIEF SUMMARY

Systems and methods for adaptive avatar dialog generation and behavioral modeling are disclosed. In some embodiments, a controller system is configured to generate one or more first user-controllable avatars on an interaction field, where the first avatars include movement controls and prompt functionality controllable by a first user to cause the first avatars to generate prompts.

In some embodiments, deep learning processing can be used to generate, modify, evaluate, score or otherwise process avatar interactions based on behavioral characteristics, learning objectives, interaction metadata or other interaction attributes associated with one or more users or avatars. A coach or other user can provide prompts, responses, scoring inputs, metadata or other feedback during an interaction session, and the feedback can be used to train, update or improve deep learning processing associated with avatar prompts, avatar responses, response evaluation, behavioral analysis or other interaction processing functions.

In some aspects, a method for adjusting model parameters that influence behavioral characteristics exhibited by an avatar during dialog interactions includes: connecting, into a session, a second client device over a network, the second client device being used by a second user serving as a coach, wherein in the session a first user interacts over the network through a first client device with an avatar presented within an interaction field, the avatar having behavioral characteristics associated with the avatar, said behavioral characteristics being used by a deep-learning process; wherein the coach interacts within the session using a session coach user interface including: an interaction field region within which interactions between the first user and the avatar are presented; an avatar control region through which the coach provides input associated with the avatar; and a coach feedback control region through which the coach provides feedback associated with the interactions; receiving, during the session and from the coach via the avatar control region, a prompt for generating dialog that is to be presented to the first user as originating from the avatar; processing the prompt to generate an avatar-matched prompt based on the behavioral characteristics associated with the avatar; providing the avatar-matched prompt over the network, the avatar-matched prompt being presented within the interaction field as originating from the avatar; receiving, from the first user, a response to the avatar-matched prompt, the response being presented to the coach within the interaction field region; automatically generating, by a deep learning process, a system score as a function of the avatar-matched prompt and the response, the system score being presented to the coach via the coach feedback control region; receiving, over the network and through the coach feedback control region, a coach score provided by the coach, the coach score representing a perception by the coach of how well an interaction of the interactions between the first user and the avatar the interaction conforms to the behavioral characteristics; comparing the system score and the coach score to determine whether substantive differences exist; and responsive to determining that substantive differences exists, updating parameters of the deep learning process, the updated parameters being used in subsequent processing of prompts to generate avatar-matched prompts based on the behavioral characteristics associated with the avatar.

In some aspects, a method for adjusting model parameters that influence behavioral characteristics exhibited by an avatar during dialog interactions includes: conducting a session in which a first user interacts with the avatar; receiving, from a coach participating in the session, a prompt intended for presentation to the first user as dialog from the avatar; processing the prompt to generate an avatar-matched prompt based on behavioral characteristics associated with the avatar and providing the avatar-matched prompt for use in the session; receiving, from the first user, a response to the avatar-matched prompt; producing, by a scoring mechanism of a system, a system score derived from the prompt and the response; receiving a coach score supplied by the coach; and responsive to detecting a substantive difference between the system score and the coach score, adjusting adaptive parameters maintained by the system, the adjusted adaptive parameters being used in subsequent processing of prompts to generate avatar-matched prompts based on the behavioral characteristics.

In some aspects, a method implemented by a dialog-generation system operating a coach-side user interface for adjusting model parameters that influence behavioral characteristics exhibited by an avatar includes: providing, to a coach, a session coach user interface for a session within which a first user interacts with an avatar, wherein said session coach user interface includes: an interaction field region within which interactions between the first user and the avatar are presented; an avatar control region through which the coach provides input associated with the avatar; and a coach feedback control region through which the coach provides feedback associated with the interactions; receiving a prompt or message provided by the coach through the avatar control region, wherein the prompt is converted into an avatar-matched prompt based on behavioral characteristics associated with the avatar; presenting, to the coach via the interaction field region, the avatar-matched prompt and a response by the first user to the avatar-matched prompt to the coach; and receiving, through the coach feedback control region, a coach score related to the avatar-matched prompt, the response, and the behavioral characteristics, wherein the coach score is utilized to adjust adaptive parameters used in subsequent processing of prompts to generate avatar-matched prompts based on the behavioral characteristics.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram of a system for controlling multicomputer interaction with deep learning and artificial intelligence, in accordance with an example embodiment of the present disclosure;

FIG. 2 is a diagram of a system for providing avatar controls, in accordance with an example embodiment of the present disclosure;

FIG. 3 is a diagram of a system for providing coach feedback controls, in accordance with an example embodiment of the present disclosure;

FIG. 4 is a diagram of an algorithm for control of multicomputer interaction with deep learning and artificial intelligence, in accordance with an example embodiment of the present disclosure; and

FIG. 5 is a diagram of an algorithm for control of multicomputer interaction with deep learning and artificial intelligence, in accordance with an example embodiment of the present disclosure.

### DETAILED DESCRIPTION

In the description that follows, like parts are marked throughout the specification and drawings with the same reference numerals. The drawing figures may be to scale and certain components can be shown in generalized or schematic form and identified by commercial designations in the interest of clarity and conciseness.

Multicomputer systems can be used for many applications where control is not an issue, such as for commercial transactions or banking. The present disclosure is directed to multicomputer systems that are used to facilitate interaction between users as well as to apply deep learning to those interactions, such as where a user can provide metadata in real time with data from the interactions themselves as input to train a deep learning process (where neural networks, artificial intelligence or other suitable automated or algorithmic learning processes are generally referred to herein as “deep learning”). Such interactions are unlike commercial transactions or banking, because the content of the transactions themselves are of interest as opposed to making a purchase or accessing a financial account. Thus, while the fact that a user made a purchase or performed a transaction might be the focus of a commercial transaction or banking transaction, the present disclosure is directed to the content of the interactions between multiple users, how that content can be augmented using artificial intelligence or deep learning, and how the augmented content can be used in a feedback mode to improve the accuracy of the artificial or deep learning processes for those interactions, among other useful systems and methods as discussed further herein.

In some embodiments, interactions between users can be facilitated through avatars having associated behavioral characteristics, learning objectives, personality attributes or other suitable interaction attributes. Deep learning processing can be used to generate, modify, evaluate or score avatar prompts, responses or other interaction content, such as to improve consistency of avatar behavior, to model selected interaction objectives, or to provide adaptive feedback associated with user interactions. In further embodiments, interaction metadata, scoring inputs, coach feedback or other interaction data can be used to train or update deep learning processing associated with avatar dialog generation, response evaluation or behavioral modeling.

In some embodiments, a coach or other user can interact with one or more avatars through a session interface that allows prompts, responses, movement controls, scoring inputs or other interaction controls to be generated, modified or evaluated during an interaction session. Deep learning processing can generate proposed prompts, proposed responses, scoring outputs or other interaction guidance, and can utilize feedback associated with the interaction session to modify or improve subsequent dialog generation, behavioral analysis or other interaction processing functions.

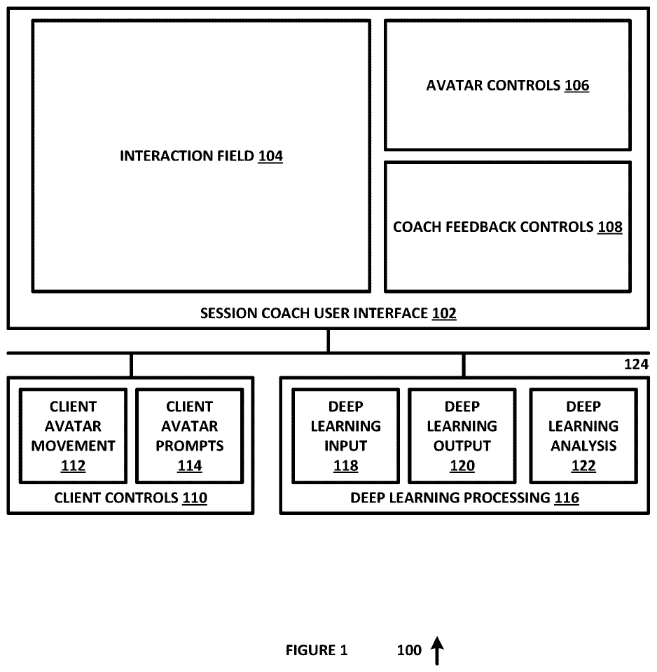

FIG. 1 is a diagram of a system 100 for controlling multicomputer interaction with deep learning and artificial intelligence, in accordance with an example embodiment of the present disclosure. System 100 includes session coach user interface 102, interaction field 104, avatar controls 106, coach feedback controls 108, client controls 110, client avatar movement 112, client avatar prompts 114, deep learning processing 116, deep learning input 118, deep learning output 120 and deep learning analysis 122, which can be arranged as shown or in other suitable arrangements, and which can be interconnected over network 124 and implemented in hardware or a suitable combination of hardware and software.

Session coach user interface 102 can be implemented as one or more algorithms operating on a suitable processing platform that can be loaded into a working memory of the processing platform to cause the processing platform to generate a session coach user interface or other suitable user interfaces for controlling multicomputer interaction with deep learning and artificial intelligence. In this example embodiment, a session coach is the primary controller, but other suitable embodiments can also or alternatively be used, such as classrooms, seminars, meetings or other applications where interaction between users occurs and requires multicomputer interaction with deep learning and artificial intelligence, as discussed further herein. In another example embodiment, session coach user interface 102 can be used in conjunction with one or more screen displays, a head mounted user interface, a virtual reality user interface, an augmented reality user interface or other suitable user interfaces.

Interaction field 104 can be implemented as one or more algorithms operating on a suitable processing platform that can be loaded into a working memory of the processing platform to cause the processing platform to generate an interaction field with a plurality of interaction controls. In one example embodiment, a session coach can control the number and functionality of the interaction controls, such as by identifying avatars, objects or other display items that a user can interact with. In this example embodiment, a client can be presented with the opportunity to select one of two or more actions, such as to open a door or to interact with the coach, where the controls for the door or coach interactions are controlled by the coach. In other example embodiments, a group of clients can be allowed to interact with a coach one at a time, where there is one active client and a plurality of standby clients that are queued for interaction in order, the clients can compete to find an object or other suitable functions can also or alternatively be provided. Likewise, interaction controls can initially be generated by deep learning processing 116 and can be subsequently controlled by a coach, a client, deep learning processing 116 or in other suitable manners. Interaction controls provide the technical feature of generating metadata for use in deep learning processing 116 or for other suitable purposes in real time, to improve the deep learning training process and for other purposes. For example, deep learning can be integrated into system 100, such as in the form of proposed avatar attributes, proposed scoring attributes and in other suitable manners.

Avatar controls 106 can be implemented as one or more algorithms operating on a suitable processing platform that can be loaded into a working memory of the processing platform to cause the processing platform to control one or more avatars in interaction field 104. In one example embodiment, avatar controls 106 can allow a user to select an avatar, to configure an avatar, to cause an avatar to move, to cause the avatar to generate user-entered statements, to cause the avatar to generate statements generated by deep learning processing 116 or to perform other suitable functions. In this example embodiment, avatar controls 106 can be generated on a screen that is separate from the screen that is used to generate interaction field 104 or coach feedback controls 108 to facilitate the ability of the coach to keep those functions separate and to avoid inadvertent entry of input intended for one system from being provided to a different system. Likewise, in a virtual or augmented environment, avatar controls 106 can be located in a different virtual location, can be accessed using a different virtual control or other suitable functions can also or alternatively be provided.

Coach feedback controls 108 can be implemented as one or more algorithms operating on a suitable processing platform that can be loaded into a working memory of the processing platform to cause the processing platform to generate one or more controls for receiving feedback from a coach. In one example embodiment, a coach can select questions and answers, interactions with a client, metadata associated with the interactions that identifies characteristics of the interaction or other suitable data for provision to deep learning processing 116 or other suitable systems, to provide the technical feature of real-time augmentation of deep learning input to facilitate use and analysis of the data. In another example embodiment, coach feedback controls 108 can include a scoring mechanism that allows the coach to review the progress that a client has made towards a plurality of goals and to update the scoring mechanism whenever the client accomplishes a goal. The scoring mechanism can select one or more prior interactions with the client for use in assessing how that interaction resulted in the associated goal being met, to input that interaction data into deep learning processing 116 for analysis or can perform other suitable functions.

Client controls 110 can be implemented as one or more algorithms operating on a suitable processing platform that can be loaded into a working memory of the processing platform to cause the processing platform to generate a client user interface or other suitable user interfaces for controlling multicomputer interaction with deep learning and artificial intelligence. In this example embodiment, a client can have limited functionality control but can respond to prompts from a coach, select controls that have been defined by a coach for deep learning processing 116, metadata associated with the client actions or responses that identifies characteristics of the interaction or other suitable data for provision to deep learning processing 116 or other suitable systems, to provide the technical feature of real-time augmentation of deep learning input to facilitate use and analysis of the data, or can perform other suitable functions, as discussed further herein. In another example embodiment, client controls 110 can be used in conjunction with one or more screen displays, a head mounted user interface, a virtual reality user interface, an augmented reality user interface or other suitable user interfaces.

Client avatar movement 112 can be implemented as one or more algorithms operating on a suitable processing platform that can be loaded into a working memory of the processing platform to cause the processing platform to control movement of an avatar for a client. In one example embodiment, the avatar can have a plurality of user-selectable movement options, such as to allow the avatar to approach different objects, enter different virtual rooms or perform other functions. The avatar movement controls can be selected or modified by the coach, deep learning processing 116 or in other suitable manners, and the client response to a modification to the controls can be used as input to deep learning processing 116 to confirm or modify predictions made by deep learning processing 116 or for other suitable purposes.

Client avatar prompts 114 can be implemented as one or more algorithms operating on a suitable processing platform that can be loaded into a working memory of the processing platform to cause the processing platform to generate client avatar prompts and to receive client avatar responses. In one example embodiment, client avatar prompts 114 can include a text to speech converter for prompts, a speech to text converter for responses, an audio recorder or other suitable functions that allow the specific interactions of the client with the coach to be recorded and analyzed. Client avatar responses can also be associated with score, questions generated by avatar controls 106, feedback generated by coach feedback controls 108 or other suitable functions, to facilitate the use of client avatar prompts and responses by system 100.

Deep learning processing 116 can be implemented as one or more algorithms operating on a suitable processing platform that can be loaded into a working memory of the processing platform to cause the processing platform to receive inputs from session coach user interface 102 and client controls 110, to analyze the inputs, to generate outputs to session coach user interface 102 and client controls 110 and to perform other suitable functions. In one example embodiment, deep learning processing 116 can be used to process data in real time, so as to generate suggested prompts for a coach during a session, to generate suggested responses to questions for a lecturer or for other suitable purposes. In another example embodiment, deep learning processing 116 can analyze data after completion of a session and can generate scoring suggestions or other data for use by a session coach, such as for a future session.

Deep learning input 118 can be implemented as one or more algorithms operating on a suitable processing platform that can be loaded into a working memory of the processing platform to cause the processing platform to receive input from client controls 110, session coach user interface 102 or other suitable input. In one example embodiment, deep learning input 118 can receive selected inputs as a function of controls from a session coach, can perform data mining on continuous input from client controls 110 and session coach user interface 102 or can receive other suitable data. Deep learning input 118 can include metadata associated with coach or client statements, control selections or other interactions, where the metadata includes selected or user-entered data fields that identify characteristics of associated training data or other suitable data for provision to deep learning processing 116 or other suitable systems, to provide the technical feature of real-time augmentation of deep learning input to facilitate use and analysis of the data. Deep learning input 118 thus provides the technical feature of solving a previously unidentified problem, namely, that inputs and outputs of a deep learning processor are often not strongly correlated for use in training. For example, a key part of a prompt for use in deep learning input could occur several statements before a reply to the prompt is received, and deep learning input 118 allows a user to indicate the training data and metadata that should be used, the expected outputs to that data and metadata input and other suitable data for use in training a deep learning system, a neural network, artificial intelligence or other suitable systems.

Deep learning output 120 can be implemented as one or more algorithms operating on a suitable processing platform that can be loaded into a working memory of the processing platform to cause the processing platform to generate one or more outputs to client controls 110, session coach user interface 102 or other suitable systems. In one example embodiment, deep learning output 120 can generate one or more suggested prompts for a coach in response to a statement or input from a client, a selected objective, or other suitable inputs. In this example embodiment, deep learning output can process data and generate a list of proposed responses, a list of proposed action items in response to a request from a coach for suggested action items, one or more controls for client controls 110 or other suitable data.

Deep learning analysis 122 can be implemented as one or more algorithms operating on a suitable processing platform that can be loaded into a working memory of the processing platform to cause the processing platform to analyze deep learning inputs and outputs. In one example embodiment, deep learning, artificial intelligence, neural networks or other suitable processes can be trained to generate responses to inputs, and to predict further input that is expected to those responses. Deep learning analysis 122 can receive the further input and can determine whether the further input matches what was predicted. The results of whether or not the further input was predicted can be used to update future responses. Likewise, deep learning analysis 122 can receive input from a coach, such as when a coach selects one of two or more proposed prompts, when a coach does not select any proposed prompt and instead generates a different prompt, a score generated by a coach that is the same or different from a proposed score or other suitable data, and can use the data to improve the predictions and guidance that is generated. In further embodiments, the data can be used to update adaptive parameters, scoring functions, prompt-selection logic or other processing parameters used in subsequent processing of prompts, avatar-matched prompts or other interactions associated with behavioral characteristics of an avatar. In further embodiments, the data can be used to modify adaptive parameters, scoring functions, prompt-selection logic or other processing parameters used in subsequent interactions.

In operation, system 100 provides for control of multicomputer interaction with deep learning and artificial intelligence, such as by allowing user interactions in a multicomputer environment to be based on suggested inputs, to receive actual responses and to determine whether the actual responses correlated with the expected responses, to generate score and to modify scoring algorithms based on actual score and for other suitable purposes.

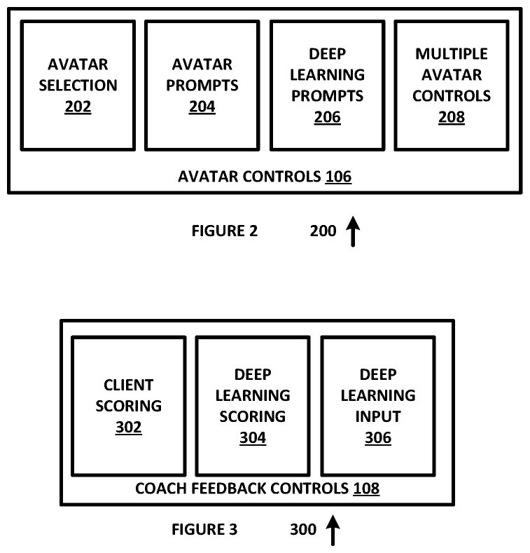

FIG. 2 is a diagram of a system 200 for providing avatar controls, in accordance with an example embodiment of the present disclosure. System 200 includes avatar controls 106 and avatar selection 202, avatar prompts 204, deep learning prompts 206 and multiple avatar controls 208, which can be arranged as shown or in other suitable arrangements, and which can be interconnected over network 124 and implemented in hardware or a suitable combination of hardware and software.

Avatar selection 202 can be implemented as one or more algorithms operating on a suitable processing platform that can be loaded into a working memory of the processing platform to cause the processing platform to generate a plurality of avatars for selection by a coach, such as by including predetermined behavioral characteristics for each avatar, by identifying specific objectives associated with each avatar or in other suitable manners. In one example embodiment, a user can identify a set of objectives for a coaching session, such as “avoid getting angry,” “be more assertive” or other suitable objectives. The behavioral characteristics can influence generation of avatar prompts, avatar-matched prompts, proposed responses, scoring outputs or other dialog interactions associated with the avatar during a session. Avatar selection 202 can generate suggested avatars for the identified objectives, in addition to guidance on the specific objectives that each avatar can be used for. Avatar selection 202 further generates controls to allow a user to select a sequence of one or more avatars, to control avatar functionality (such as rooms that the avatar is in) or other suitable functions.

Avatar prompts 204 can be implemented as one or more algorithms operating on a suitable processing platform that can be loaded into a working memory of the processing platform to cause the processing platform to generate prompts for use by a coach, such as where a speech converter is used to allow a coach to assume a role of an avatar, where the coach enters text that an avatar will speak using a text to voice processor, by presenting a menu of proposed responses or in other suitable manners. Avatar prompts 204 can also be used to process a proposed response from an avatar and to provide real-time suggestions on how to modify the response to conform to behavioral attributes of the avatar, such as to prevent a coach from inadvertently falling out of character with the avatar. In further embodiments, avatar prompts 204 can process prompts received from a coach to generate avatar-matched prompts that conform to behavioral characteristics associated with the avatar.

Deep learning prompts 206 can be implemented as one or more algorithms operating on a suitable processing platform that can be loaded into a working memory of the processing platform to cause the processing platform to generate deep learning prompts, such as suggestions for the coach to repeat or modify in response to objectives, client responses, user interface control modifications or for other suitable purposes. In one example embodiment, deep learning prompts 206 can include specific prompts for an avatar based on associated objectives, with guidelines for scoring a client response to the prompt or other suitable data. In another example embodiment, deep learning prompts 206 can be generated by a deep learning processor in response to real time dialog or in other suitable manners.

Multiple avatar controls 208 can be implemented as one or more algorithms operating on a suitable processing platform that can be loaded into a working memory of the processing platform to cause the processing platform to generate multiple avatar controls, such as when the coach selects two or more avatars to interact in a specific manner. In one example embodiment, two avatars can be selected to provide a good example of an interaction, such as for responding to criticism or anger. In this example, one avatar can be provided with negative or unacceptable behavior prompts, and the second avatar can be provided with positive or acceptable behavior prompts. A coach user interface control can be used to allow a coach to vary the response, to demonstrate incrementally better or worse behavior, or for other suitable purposes.

In operation, system 200 allows avatars to be controlled by a coach or other primary user, such as to allow the avatars to provide responses to clients that reinforce behavioral objectives, to demonstrate examples of acceptable and unacceptable behavior or other suitable functions.

FIG. 3 is a diagram of a system 300 for providing coach feedback controls, in accordance with an example embodiment of the present disclosure. System 300 includes coach feedback controls 108 and client scoring 302, deep learning scoring 304 and deep learning input 306, which can be arranged as shown or in other suitable arrangements, and which can be interconnected over network 124 and implemented in hardware or a suitable combination of hardware and software.

Client scoring 302 can be implemented as one or more algorithms operating on a suitable processing platform that can be loaded into a working memory of the processing platform to cause the processing platform to generate a score for a client. In one example embodiment, the client score can be generated in response to client responses to prompts, where the prompts are associated with a specific scoring component. In this example embodiment, the coach can generate a score based on one or more client responses, the client responses can be processed in real time by an artificial intelligence processor to generate suggested scores or other suitable processes can also or alternatively be used. The suggested score can be generated as a function of an avatar prompt, an avatar-matched prompt, a client response, interaction metadata or other session data associated with interactions between a client and an avatar.

Deep learning scoring 304 can be implemented as one or more algorithms operating on a suitable processing platform that can be loaded into a working memory of the processing platform to cause the processing platform to process deep learning scores and whether a coach accepts or declines a deep learning score. In one example embodiment, a coach can be presented with a suggested score for an objective in response to processing of real time interactions with a client, and deep learning scoring 304 can be used to determine whether the score was entered or rejected. In this example embodiment, if a score is rejected, the coach can be prompted to provide additional information regarding why the proposed score was rejected, to improve the scoring function of the deep learning processor.

Deep learning input 306 can be implemented as one or more algorithms operating on a suitable processing platform that can be loaded into a working memory of the processing platform to cause the processing platform to allow a user to identify input for a deep learning process. In one example embodiment, a deep learning processor can have a training mode of operation where inputs are used to update data processing algorithms. Deep learning input 306 allows a user to identify specific interactions between parties for use in training mode, such as examples of proper responses to prompts, improper responses to prompts, examples of proper scoring suggestions, examples of improper scoring suggestions and so forth.

In operation, system 300 allows a coach or other suitable user to provide feedback to a client scoring system, deep learning systems or other suitable feedback. The feedback can include data fields associated with interactions between a coach and a client, a teacher and a student, meeting or conference attendees or other suitable parties, as well as metadata associated with the timing, characteristics or other suitable metadata that can be obtained in real time by a user and used to improve the training of a deep learning system as discussed further herein.

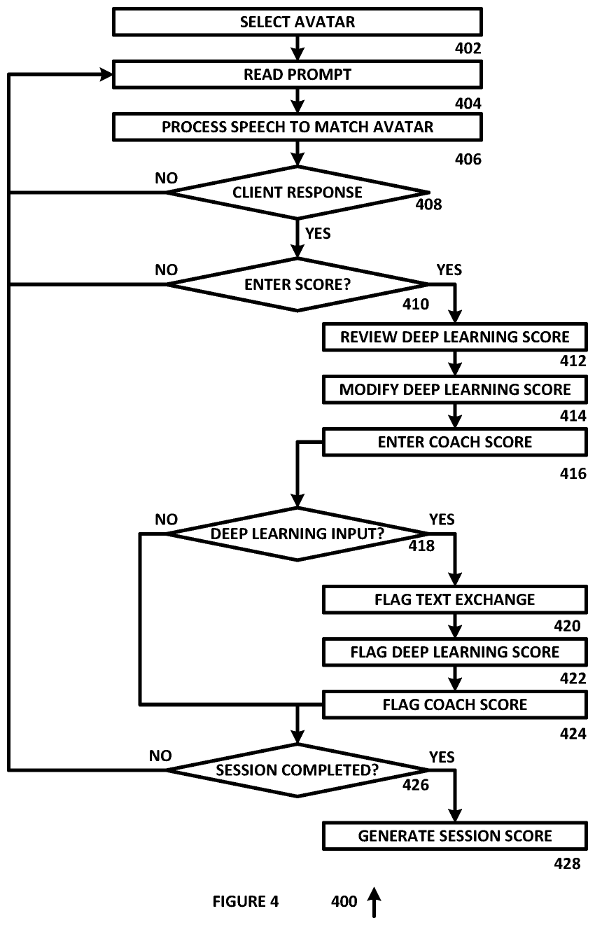

FIG. 4 is a diagram of an algorithm 400 for control of multicomputer interaction with deep learning and artificial intelligence, in accordance with an example embodiment of the present disclosure. Algorithm 400 can be implemented in hardware or a suitable combination of hardware and software.

Algorithm 400 begins at 402, where an avatar is selected. In one example embodiment, the avatar can be selected from a set of avatars having associated behavioral characteristics, learning objectives or other suitable functional attributes that are associated with a specific avatar, such as for the purpose of coaching, instruction and other suitable functions. The algorithm then proceeds to 404.

At 404, a prompt is read. In one example embodiment, the prompt can be selected from a list of suggested prompts, the prompt can be generated by a coach with suitable training and knowledge of behavioral attributes of an avatar or other suitable prompts can be used. The algorithm then proceeds to 406.

At 406, the prompt is processed to generate speech that matches the associated avatar. In one example embodiment, a coach can speak a prompt and the voice signals can be processed to make the voice sound like a different person, such as where the coach is providing counseling and wants to portray specific behavioral attributes for an avatar to a client without stepping out of the role of the coach. In another example embodiment, prerecorded segments can be selected, text to speech processing can be used to generate voice signals from text or other suitable processes can also or alternatively be used. The algorithm then proceeds to 404.

At 408, it is determined whether a client response has been received. If it is determined that a client response has not been received, the algorithm returns to 404, otherwise the algorithm proceeds to 410.

At 410, it is determined whether a score has been entered. If a score has not been entered, the algorithm returns to 404, otherwise the algorithm proceeds to 412.

At 412, a deep learning score is displayed and reviewed. In one example embodiment, the deep learning score can be machine generated, the deep learning score can be selected from a list based on a similarity of a client response to a response on the list or other suitable processes can also or alternatively be used. The algorithm then proceeds to 414.

At 414, the deep learning score is modified. In one example embodiment, a user can indicate that the deep learning score was incorrect, and that indication can be used as metadata input to improve the accuracy of the deep learning system. In further embodiments, differences between a deep learning score and a coach score can be used to determine whether substantive differences exist between system-generated scoring and coach evaluation of interactions associated with an avatar. Likewise, other suitable processes can also or alternatively be used. The algorithm then proceeds to 416.

At 416, a coach score is entered. In one example embodiment, the coach score can be in addition to the deep learning score, can include non-numerical scoring components such as metadata fields, textual analyses or other suitable processes can also or alternatively be used. The algorithm then proceeds to 418.

At 418, it is determined whether deep learning input has been selected. If it is determined that deep learning input has not been selected, the algorithm proceeds to 426, otherwise the algorithm proceeds to 420.

At 420, a text exchange is flagged for entry into a deep learning system. In one example embodiment, the text exchange can include one or more queries from a coach and responses from a client that the coach has selected to be used to indicate a correct response, an incorrect response, a response that indicates a particular condition, metadata or other suitable input for training a deep learning system. The input can include additional metadata tags associated with the deep learning process, such as metadata tags that indicate the relevant portions of the text exchange, that the text exchange has certain attributes, or other suitable metadata. as discussed above. The algorithm then proceeds to 422.

At 422, a deep learning score is flagged. In one example embodiment, a deep learning score that is outside of a reasonable estimate can be flagged by a user to update the deep learning algorithm, such as to provide an input with the indication of whether the score is too low, too high, what the score should be, whether the score was received before scoring was complete and so forth. With the additional input, the deep learning algorithm can be trained to provide a more correct score in the future. The algorithm then proceeds to 424.

At 424, a coach score is flagged. In one example embodiment, the coach score can be flagged when it varies from a deep learning score, when a user wants the score and the basis for the score to be provided for training the deep learning process or for other suitable purposes. The algorithm then proceeds to 426.

At 426, it is determined whether the session has been completed. In one example embodiment, completion of the session can occur after a predetermined period of time, when a user has selected a control, when a session score has been entered or in other suitable manners. Session completion can also cause training data to be submitted to the deep learning system, such as to allow a user to review the material before submitting it, to indicate that it should not be submitted with session completion or in other suitable manners. If it is determined that the session has not been completed, the algorithm returns to 404, otherwise the algorithm proceeds to 428.

At 428, a session score is generated. In one example embodiment, the session score can include an overall deep learning score and overall user score, score components for different segments of the session (such as communication, progress, participation and so forth), or other suitable score.

In operation, algorithm 400 provides for control of multicomputer interaction with deep learning and artificial intelligence. While algorithm 400 is shown with specific steps in a specific flowchart order, a person of skill in the art will understand that the order of functions can be changed, modified, additional functions can be added and certain steps can be omitted without departing from the inventive features. Likewise, algorithm 400 can be implemented using object-oriented programming, a ladder diagram, a state diagram, other suitable programming conventions or in other suitable manners.

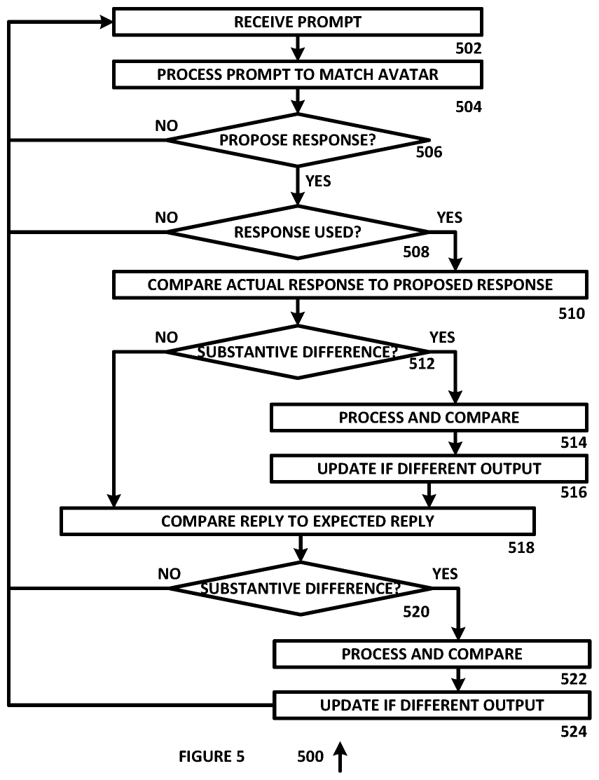

FIG. 5 is a diagram of an algorithm 500 for control of multicomputer interaction with deep learning and artificial intelligence, in accordance with an example embodiment of the present disclosure. Algorithm 500 can be implemented in hardware or a suitable combination of hardware and software.

Algorithm 500 begins at 502 where a prompt is received. In one example embodiment, the prompt can be entered by a coach for a predetermined avatar, such as by selecting a prompt from a list of proposed prompts, entering text, speaking or in other suitable manners. The algorithm then proceeds to 404.

At 504, the prompt is processed to match an avatar. In one example embodiment, a user can recite the prompt and the recited prompt can be processed to create a voice sound having predetermined frequency characteristics, to create the appearance of a different speaker to a client. In another example embodiment, a deep learning process can be used that generates prompts that match personality characteristics of an avatar, such as to match an age, education level, personality trait or other suitable personality characteristics. In this example embodiment, a proposed word in the response can be replaced with a different word that has the same meaning but which reflects a higher or lower education level, an older or younger person and so forth. The algorithm then proceeds to 506.

At 506, it is determined whether a response is proposed. In one example embodiment, the response can be proposed after a reply has been received from a user, such as after processing the reply from the user with a deep learning system, an artificial intelligence system or in other suitable manners. Likewise, if the reply from the user cannot be processed due to a signal error or for some other reason, the user can be prompted to repeat their reply. If it is determined that a response is not proposed, then the algorithm proceeds to 502, otherwise the algorithm proceeds to 508.

At 508, it is determined whether a proposed response has been used. In one example embodiment, the decision by a user not to use a proposed response can result in the delivery of a user-entered response, updating a learning algorithm for a deep learning process with metadata to reflect that the proposed response was not used or other suitable processes can be implemented. If it is determined that the proposed response has not been used, the algorithm returns to 502, otherwise the algorithm proceeds to 510.

At 510, the actual response is compared to a proposed response. The algorithm then proceeds to 512.

At 512, it is determined whether there is a substantive difference between the actual response and the proposed response. In one example embodiment, the response from the user can be processed grammatically and compared to a proposed response, to determine whether any variations between the proposed response and the received response are substantive or otherwise change the meaning of the response, and proposed modifications can be generated. If no substantive difference is detected, the algorithm proceeds to 518, otherwise the algorithm proceeds to 514.

At 514, the substantive differences are processed to determine whether a meaning has changed and are compared to an intended meaning. In one example embodiment, the user can be notified that the meaning between the proposed response and the actual response has been detected, and the user can respond with an indication of whether or not the assessment is correct, such as for training a deep learning process, to provide metadata tags for such training or for other suitable purposes. The algorithm then proceeds to 516.

At 516, a deep learning algorithm is updated if the substantive difference exists and was intended. The update can include modification of adaptive parameters used in subsequent processing of prompts to generate avatar-matched prompts associated with behavioral characteristics of an avatar. In one example embodiment, a training input can be generated for a deep learning algorithm, a neural network, or other suitable processes can be used. The algorithm then proceeds to 518.

At 518, a reply to the prompt is processed to determine whether it is an expected reply. In one example embodiment, a yes or no question can be processed to determine whether the answer is yes, no or something else. Likewise, a prompt can have a number of predetermined expected responses, such as “good,” “bad,” a number or other expected responses that can be determined in advance. The algorithm then proceeds to 520.

At 520, it is determined whether a substantive difference has been identified. If no substantive difference has been identified, the algorithm returns to 502, otherwise the algorithm proceeds to 522.

At 522, the reply is processed and compared to the expected reply. In one example embodiment, a user can indicate with metadata tags whether the reply was acceptable even if is not substantively equivalent to an expected reply, the response can be categorized by the user into one of a plurality of predetermined metadata tag categories (such as acceptable, unacceptable, non-cooperative and so forth). The algorithm then proceeds to 404.

At 524, an update to deep learning algorithm or other suitable system is generated if the reply was different from an expected reply. In one example embodiment, the update can include data and associated metadata, can be scheduled for later application, the update can be submitted after it has been approved by a user or other suitable processes can also or alternatively be used.

In operation, algorithm 500 provides for control of multicomputer interaction with deep learning and artificial intelligence. While algorithm 500 is shown with specific steps in a specific flowchart order, a person of skill in the art will understand that the order of functions can be changed, modified, additional functions can be added and certain steps can be omitted without departing from the inventive features. Likewise, algorithm 500 can be implemented using object-oriented programming, a ladder diagram, a state diagram, other suitable programming conventions or in other suitable manners.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

Although the subject matter has been described in language specific to structural features and/or acts, it is to be understood that the subject matter defined in the appended claims is not necessarily limited to the specific features or acts described above. Rather, the specific features and acts described above are disclosed as examples, implementing the claims and other equivalent features and acts; they are intended to be within the scope of the claims.

What is claimed is:

1. A method for adjusting model parameters that influence behavioral characteristics exhibited by an avatar during dialog interactions, the method comprising:
connecting, into a session, a second client device over a network, the second client device being used by a second user serving as a coach, wherein in the session a first user interacts over the network through a first client device with an avatar presented within an interaction field, the avatar having behavioral characteristics associated with the avatar, said behavioral characteristics being used by a deep learning process;
wherein the coach interacts within the session using a session coach user interface comprising:
an interaction field region within which interactions between the first user and the avatar are presented;
an avatar control region through which the coach provides input associated with the avatar; and
a coach feedback control region through which the coach provides feedback associated with the interactions;
receiving, during the session and from the coach via the avatar control region, a prompt for generating dialog that is to be presented to the first user as originating from the avatar;
processing the prompt to generate an avatar-matched prompt based on the behavioral characteristics associated with the avatar;
providing the avatar-matched prompt over the network, the avatar-matched prompt being presented within the interaction field as originating from the avatar;
receiving, from the first user, a response to the avatar-matched prompt, the response being presented to the coach within the interaction field region;
automatically generating, by a deep learning process, a system score as a function of the avatar-matched prompt and the response, the system score being presented to the coach via the coach feedback control region;
receiving, over the network and through the coach feedback control region, a coach score provided by the coach, the coach score representing a perception by the coach of how well an interaction of the interactions between the first user and the avatar the interaction conforms to the behavioral characteristics;
comparing the system score and the coach score to determine whether substantive differences exist; and
responsive to determining that substantive differences exists, updating parameters of the deep learning process, the updated parameters being used in subsequent processing of prompts to generate avatar-matched prompts based on the behavioral characteristics associated with the avatar.

2. The method of claim 1, wherein the processing of the prompt further comprises:
generating a menu of proposed avatar responses and presenting the menu to the coach, and providing real-time suggestions indicating how a selected proposed response is able to be modified to conform to the behavioral characteristics associated with the avatar.

3. The method of claim 1, wherein the processing of the prompt to generate the avatar-matched prompt includes: processing the prompt to generate dialog that reinforces behavioral objectives associated with the avatar, and
wherein updating the parameters of the deep learning process comprises adjusting the parameters based on the coach score indicating whether the interaction demonstrates behavior defined acceptable or unacceptable.

4. The method of claim 1, wherein the processing of the prompt includes transforming a spoken version of the prompt to generate avatar speech having frequency or voice characteristics selected to portray the behavioral characteristics associated with the avatar.

5. A method for adjusting model parameters that influence behavioral characteristics exhibited by an avatar during dialog interactions, the method comprising:
conducting a session in which a first user interacts with the avatar;
receiving, from a coach participating in the session, a prompt intended for presentation to the first user as dialog from the avatar;
processing the prompt to generate an avatar-matched prompt based on behavioral characteristics associated with the avatar and providing the avatar-matched prompt for use in the session;
receiving, from the first user, a response to the avatar-matched prompt;
producing, by a scoring mechanism of a system, a system score derived from the prompt and the response;
receiving a coach score supplied by the coach; and
responsive to detecting a substantive difference between the system score and the coach score, adjusting adaptive parameters maintained by the system, the adjusted adaptive parameters being used in subsequent processing of prompts to generate avatar-matched prompts based on the behavioral characteristics.

6. The method of claim 5, wherein the producing of the system score and the adjusting of the adaptive parameters further comprises:
using deep learning input that includes two or more of: interaction metadata, avatar control selections, questions generated by avatar controls, or feedback generated by coach feedback controls.

7. The method of claim 5, wherein the adaptive parameters are adjusted based on coaching objectives associated with the avatar, the coaching objectives influencing generation of prompts associated with the behavioral characteristics during the session.

8. The method of claim 5, wherein the processing of the prompt comprises:
generating a menu of proposed avatar responses; and
presenting the menu to the coach.

9. The method of claim 5, further comprising:
providing, to the coach, real-time suggestions on how a proposed response is to be modified to conform to the behavioral characteristics of the avatar.

10. The method of claim 5, wherein the generating of the avatar-matched prompt further comprises:
generating prompts that model behavioral responses to criticism or anger, and wherein the adaptive parameters are adjusted based on coach scoring of an appropriateness of the modeled responses for the behavioral characteristics of the avatar.

11. The method of claim 5, wherein the generating of the avatar-matched prompt comprises:
generating prompts that provide responses reinforcing behavioral objectives defined by the coach for the session.

12. The method of claim 5, wherein the processing of the prompt includes transforming a voice signal provided by the coach to generate avatar speech having voice qualities selected to express the behavioral characteristics associated with the avatar.

13. The method of claim 5, further comprising:
receiving, from the coach, an instruction to complete the session; and
in response to receiving the instruction, generating training data including the prompt, the avatar-matched prompt, the response, the system score, and the coach score.

14. The method of claim 13, further comprising:
presenting the training data to the coach for review, and
responsive to coach permission after the review, submitting the reviewed training data to the system for use in adjusting the adaptive parameters.

15. The method of claim 5, wherein the processing of the prompt to generate the avatar-matched prompt comprises:
processing a spoken version of the prompt to generate speech having predetermined frequency characteristics selected to create an appearance of a different speaker from the coach, the different speaker corresponding to the avatar and the frequency characteristics corresponding to the behavioral characteristics.

16. The method of claim 5, wherein processing the prompt to generate the avatar-matched prompt includes modifying wording or phrasing of the prompt to match personality characteristics associated with the avatar, including one or more of an age characteristic, an education-level characteristic, a personality trait, or another behavioral characteristic of the avatar.

17. A method implemented by a system configured to generate avatar dialog operating a coach-side user interface for adjusting model parameters that influence behavioral characteristics exhibited by an avatar, the method comprising:
providing, to a coach, a session coach user interface for a session within which a first user interacts with an avatar, wherein said session coach user interface comprises:
an interaction field region within which interactions between the first user and the avatar are presented;
an avatar control region through which the coach provides input associated with the avatar; and
a coach feedback control region through which the coach provides feedback associated with the interactions;
receiving a prompt or message provided by the coach through the avatar control region, wherein the prompt is converted into an avatar-matched prompt based on behavioral characteristics associated with the avatar;
presenting, to the coach via the interaction field region, the avatar-matched prompt and a response by the first user to the avatar-matched prompt to the coach; and
receiving, through the coach feedback control region, a coach score related to the avatar-matched prompt, the response, and the behavioral characteristics, wherein the coach score is utilized to adjust adaptive parameters used in subsequent processing of prompts to generate avatar-matched prompts based on the behavioral characteristics.

18. The method of claim 17, wherein the avatar control region is rendered in a virtual or augmented-reality environment at a location separate from the interaction field region and the coach feedback control region, thereby enabling the coach to keep avatar-related functions separate and to avoid inadvertent entry of input intended for the avatar into another portion of the session coach user interface.

19. The method of claim 17, wherein the coach feedback control region comprises two or more feedback controls selected from: questions and answers, interaction metadata identifying characteristics of the interactions, controls for providing data to deep learning processing, and a scoring mechanism for reviewing progress toward goals.

20. The method of claim 17, wherein the avatar control region further includes avatar movement controls that allow the coach to select or modify movement options of the avatar, and wherein client responses to the selected or modified movement options are used as input for adjusting the adaptive parameters that influence the behavioral characteristics exhibited by the avatar.
